(19) United States
(12) Patent Application Publication
(10) Pub. No.: US 2025/0252442 A1
(43) Pub. Date: Aug. 7, 2025

(54) DISTRIBUTABLE SECURE TRANSACTION OBJECT

(71) Applicant: Entrust Corporation, Shakopee, MN (US)

(72) Inventors: STEVE CLERMONT, Ottawa (CA); RICHARD GAUTHIER, Ottawa (CA); ANA NEGRETE, Ottawa (CA); AREK WOJCIECHOWSKI, Ottawa (CA)

(21) Appl. No.: 19/042,698

(22) Filed: Jan. 31, 2025

Related U.S. Application Data
(60) Provisional application No. 63/549,270, filed on Feb. 2, 2024.

(51) Int. Cl. G06Q 20/40; G06Q 20/38

(52) U.S. Cl. CPC G06Q 20/4014; G06Q 20/3827; G06Q 20/3829

(57) ABSTRACT

A distributable secure transaction object is provided. In examples, the secure transaction object is generated on a server using identifying information of a user, such as biometric information or information associated with an identification document of the user (e.g., a passport). After generation, the secure transaction object is transmitted to a user device where it is stored. The secure transaction object can be used from the user device to authenticate the user in future transactions. Additionally, the secure transaction object is deleted from the server after it is transmitted to the user device.

### CROSS-REFERENCE TO RELATED APPLICATIONS

This application claims priority to U.S. Provisional Patent Application No. 63/549,270 filed Feb. 2, 2024, the disclosure of which is incorporated herein by reference in its entirety.

### BACKGROUND

For many interactions, such as transactions, users may need to be authenticated to validate that the user is who he claims to be. Part of the authentication process may require a user to provide an identification document, such as a passport, to authenticate the user, and the identification document also may need to be authenticated to confirm that the identification document is authentic and belongs to the user. However, the user may not always carry an identification document required for an authentication process with him at all times, which may prevent the user from engaging in interactions that require authentication.

Additionally, some interactions may be expedited by allowing users to complete the authentication process in advance of the interaction. However, any identifying information, such as biometric information, submitted by a user may need to be stored from the time of authentication until the interaction occurs to validate the user at the time of the interaction. Prolonged storage of users' biometric information or other identifying information may put the information at risk of being compromised.

### SUMMARY

In accordance with aspects of the present disclosure, a secure transaction object is provided. In example aspects, the secure transaction object includes identifying information, such as biometric information, associated with a user that may be used to authenticate a user during a transaction or other interaction.

In a first aspect, a method of generating secure transaction objects for authentication of users is provided. User identifying information is received. A first key is generated based on at least some of the user identifying information. A secure transaction object is generated based on at least some of the user identifying information. The secure transaction object is associated with the first key. The secure transaction object is signed. A second key is received. In response to determining that the second key matches the first key, the secure transaction object is transmitted. After transmission, the secure transaction object is deleted.

In a second aspect, a method of generating secure transaction objects for authentication of users is provided. User identifying information is received and submitted to a server. A key is generated based on at least some of the user identifying information. A secure transaction object is requested from the server. The request includes the key. The secure transaction object is received from the server if the key matches a corresponding key generated by the server.

In a third aspect, a system for generating secure transaction objects for authentication of users is provided. The system includes one or more processors and one or more computer-readable storage devices. The storage devices store data instructions that, when executed by the one or more processors, cause the system to receive user identifying information, generate a first key, generate a secure transaction object, receive a second key, transmit the secure transaction object, and delete the secure transaction object. The first key is generated based on at least some of the user identifying information. The secure transaction object is generated based on at least some of the user identifying information. The secure transaction object is associated with the first key. The secure transaction object is transmitted in response to determining that the second key matches the first key. After the secure transaction object is transmitted, the secure transaction object is deleted.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example system for issuing secure transaction objects.

FIG. 2 illustrates another example system for issuing secure transaction objects.

FIG. 3 illustrates a flowchart of an example method of issuing secure transaction objects.

FIG. 4 illustrates a flowchart of another example method of issuing secure transaction objects.

FIG. 5 illustrates a flowchart of an example method of generating secure transaction object keys.

FIG. 6 illustrates an example message flow diagram for generating secure transaction object keys.

FIG. 7 illustrates an example message flow diagram for generating secure transaction objects.

FIG. 8 illustrates an example message flow diagram for receiving secure transaction objects.

FIG. 9 illustrates an example of a secure transaction object.

FIG. 10 illustrates an example system for authenticating users with secure transaction objects.

FIG. 11 illustrates a flowchart of an example method of authenticating users with secure transaction objects.

FIG. 12 illustrates a flowchart of another example method of authenticating users with secure transaction objects.

FIG. 13 illustrates an example computing device on which aspects of the present disclosure can be performed.

### DETAILED DESCRIPTION

In accordance with aspects of the present disclosure, a distributable secure transaction object is provided. In example aspects, the secure transaction object includes identifying information, such as biometric information, associated with a user that may be used to authenticate the user during a transaction or other interaction. While example embodiments included herein describe issuing a secure transaction object for authenticating a user for travel, the secure transaction objects described herein may be used to authenticate users in other contexts, including for financial transactions.

In example embodiments, the secure transaction object includes a virtual credential representative of an identification document. In some instances, the identification document may be a travel document, such as a user's passport, and the secure transaction object may include a digital travel credential (DTC) of the user's passport. By including the virtual credential of the travel document in the secure transaction object, the user may use the secure transaction object for authentication while traveling without the need to carry a physical travel document.

In examples, the secure transaction object is generated by an identity verification service and transmitted from the identity verification service to a user device, where the secure transaction object is stored. The secure transaction object stored on the user device may be used to authenticate a user during future transactions. Further, in some examples, after being transmitted to the user device, the identity verification service deletes any cognizable version of the secure transaction object and associated user identifying information that would otherwise be maintained by the identity verification service. Accordingly, the secure transaction object and associated user identifying information is not stored by the identity verification service and at risk of being compromised.

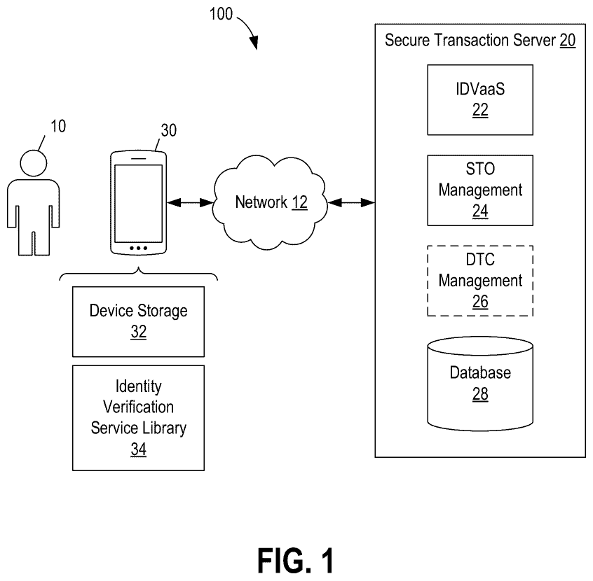

Turning now to FIG. 1, an example secure transaction object issuance system 100 is shown. In the illustrated embodiment, the system 100 includes a secure transaction server 20 connected to a user device 30 via a network 12, such as the Internet. The secure transaction server 20 includes an identity verification system 22, a secure transaction object management system 24, and a database 28. In some embodiments, the secure transaction server 20 may optionally include a digital travel credential management system 26. Although depicted as a single server, the secure transaction server 20 may include multiple servers in many embodiments. The user device 30 includes a device storage 32 and an identity verification service library 34.

As described further herein, a user 10 may use the system 100 to provision a secure transaction object for use in authenticating the user 10 in future transactions. In an embodiment, the user 10 uses the user device 30 to transmit biometric information or other identifying information to the secure transaction server 20. In an example, the identity verification service library 34 is used in the capture and transmission of biometric information or other identifying information. The identity verification service library 34 transmits the captured information to the identity verification system 22 on the secure transaction server 20. The identity verification service library 34 further uses at least some of the captured information to generate a first secure transaction object key, which is stored in the device storage 32.

After receiving the captured information, the identity verification system 22 generates a second secure transaction object key corresponding to the first secure transaction object key generated on the user device 30. In an example, the second secure transaction object key and the captured information are stored in the database 28.

At least some of the captured information is also used by the secure transaction object management system 24 to generate a secure transaction object, which is temporarily stored in the database 28. In an example, the same captured information is used to generate the secure transaction object as is used to generate the first and second secure transaction object keys. In an embodiment, the secure transaction object management system 24 also uses a digital travel credential generated by the digital travel credential management system 26 in the generation of the secure transaction object. The digital travel credential management system 26 may use at least some of the captured information to generate the digital travel credential. In an embodiment, the captured information used by the digital travel credential management system 26 to generate the digital travel credential is different from the captured information used by the secure transaction object management system 24 to generate the secure transaction object. In an example, the captured information used by the digital travel credential management system 26 includes information from a travel document of the user 10 (e.g., a passport).

After the secure transaction object is generated by the secure transaction server 20, the user device 30 uses the first secure transaction object key to retrieve the secure transaction object from the secure transaction server 20. The user device 30 transmits the first secure transaction object key to the secure transaction server 20, and if the first secure transaction object key matches the second secure transaction object key on the secure transaction server 20, the secure transaction server 20 transmits the secure transaction object to the user device 30. The secure transaction object may be stored in the device storage 32 of the user device 30. The user 10 can then use the saved secure transaction object to authenticate the user 10 in future transactions. In an example, the secure transaction object includes biometric information or other identifying information that can be used to authenticate the user 10.

In embodiments, after transmitting the secure transaction object, the secure transaction server 20 deletes the secure transaction object as well as the captured information about the user 10 from the database 28. By deleting the secure transaction object and the captured information about the user 10, the secure transaction object and information cannot be extracted from the database 28 by malicious actors, providing extra security for the user 10.

In other embodiments, the secure transaction server 20 creates a one-way hash of the secure transaction object and stores that hash, e.g., in database 28. As noted above, this hash may be retained in the database 28. However, because the hash is a one-way hash, the secure transaction object itself may not be reconstructed. In the various embodiments contemplated herein, because the secure transaction object and information about the user 10 are deleted from (or not recoverable at) the secure transaction server 20, malicious actors cannot access this information through the secure transaction server 20, protecting the user 10. By keeping the hash of the secure transaction object, the secure transaction object can quickly be validated when returned by the user as a hash of the received secure transaction object can be compared against the stored hash.

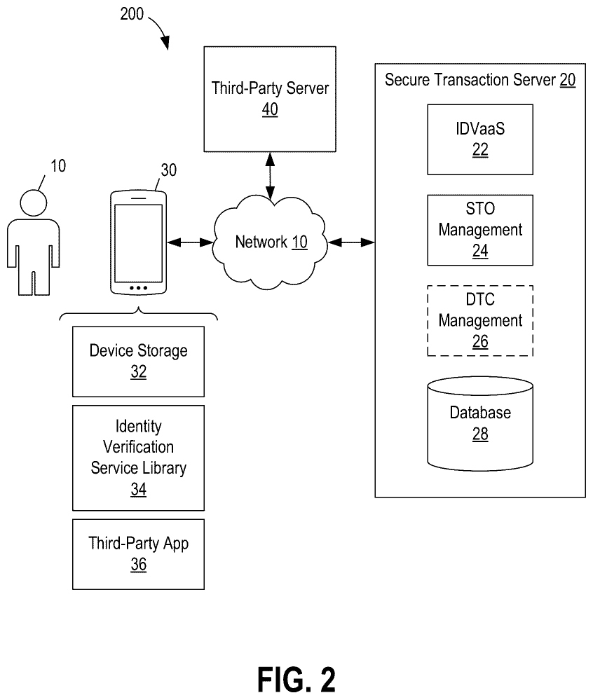

FIG. 2 illustrates another example of a secure transaction object issuance system 200. The system 200 is similar to the example secure transaction object issuance system 100 depicted in FIG. 1 and further includes a third-party server 40 associated with a third-party application 36 executing on the user device 30. In an example, the third-party application 36 and the third-party server 40 operate to provide services for the user 10. In one particular example, the third-party server 40 may provide travel services for the user 10, such as train or airline services. For example, the user 10 may use the third-party application 36 to purchase a train ticket, which may require authentication of the user 10 and verification of a travel document (e.g., passport or other identification document usable for border crossing) of the user 10. In alternative examples, the third-party application 36 and the third-party server 40 may operate to provide other services for the user 10 that require authentication of the user 10, including financial services.

During authentication of the user 10, the third-party application 36 may access the identity verification service library 34 to authenticate the user 10 and create a secure transaction object for the user 10. The secure transaction object may authenticate the user 10 during a future transaction with the third-party. For example, if the secure transaction object was generated in conjunction with the user 10 purchasing a train ticket, the secure transaction object may be used at a later time to authenticate the user 10 at a train station. In this example, if a passport or other travel document of the user 10 was authenticated during the creation of the secure transaction object, a digital travel credential of the passport may be included in the secure transaction object, allowing the user 10 to use the secure transaction object to authenticate the user 10 at the train station without needing to provide a physical copy of the passport at the train station.

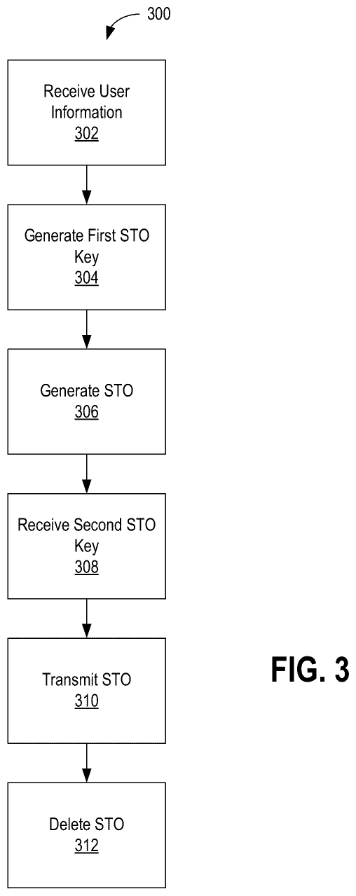

FIG. 3 illustrates a flowchart of an example method 300 of issuing a secure transaction object. The method 300 includes operations 302, 304, 306, 308, 310, 312. In an example, the method 300 may be performed by the system 100 described above in conjunction with FIG. 1 or the system 200 described above in conjunction with FIG. 2. For example, the method 300 may be performed by the secure transaction server 20 depicted in FIGS. 1 and 2.

The operation 302 includes receiving user information. In an example, the user information includes personal identifiable information about a user. For example, the user information may include contact information of the user, such as an email address and a phone number of the user. In another example, the user information may include biometric information of the user, such as a self-portrait of the user, a fingerprint image of the user, and an image of the user for liveness checking. In another example, the user information includes information about an identification document of the user—e.g., a passport or other user identity document. The information from an identification document may include information captured in an image of the document (e.g., an image of an identity page or a machine-readable zone of a passport) or information captured by reading an integrated circuit embedded within the document (e.g., reading an embedded electronic microprocessor chip of a biometric passport). In a further example, the user information may include an identification number unique to a data capture workflow.

In an embodiment, the user information is received by a secure transaction server from a user device. For example, an identity verification service library on the user device may be used to capture and transmit the user information to the secure transaction server over a network.

The operation 304 includes generating a first secure transaction object key. The first secure transaction object key is associated with a secure transaction object record and is used to identify and access a secure transaction object after the secure transaction object is generated. In an example, the first secure transaction object key is generated using hashes of at least some of the user information received during the operation 302. Accordingly, by requiring a matching secure transaction object key to access the secure transaction object, the secure transaction object is protected from unauthorized access as the user information is necessary to generate a corresponding secure transaction object key and other actors do not have all of the necessary user information.

In an embodiment, the first secure transaction object key is generated by an identity verification service operating on a secure transaction server. In this embodiment, the first secure transaction object key may be stored in a database of the secure transaction server.

The operation 306 includes generating a secure transaction object. The secure transaction object is generated using at least some of the user information received during the operation 302. In an example, the first secure transaction object key and the secure transaction object are generated based on the same user information. In alternative examples, the first secure transaction object key and the secure transaction object may be generated based on different user information. The generated secure transaction object may be temporarily stored in the secure transaction record associated with the first secure transaction object key generated during the operation 304.

In an embodiment, the generated secure transaction object is signed. The signature of the secure transaction object may be used to verify that the secure transaction object is not modified after it is generated. In another embodiment, the secure transaction object may additionally or alternatively be encrypted.

In an embodiment, the secure transaction object is generated by a secure transaction object background process and a secure transaction object microservice operating on a secure transaction server. In this embodiment, the secure transaction object may be temporarily stored in a database of the secure transaction server.

In an example embodiment, the secure transaction object is signed using an external key management system. In this example, a hash of the secure transaction object and a key are transmitted to the external key management system. The external key management system returns a signature and an algorithm used to generate the signature, which are added to the secure transaction object, as described further herein. Accordingly, the secure transaction object can be validated by the secure transaction server.

In some embodiments, the secure transaction object may additionally or alternatively be encrypted using the external key management system. In such embodiments, the external key management system may generate and use a key pair for encryption and decryption of the secure transaction object. In an example, the external key management system maintains the key pair and the secure transaction object can be decrypted by the external key management system. In an alternative example, the secure transaction server receives a key from the external key management system, and the secure transaction server can decrypt the secure transaction object.

The operation 308 includes receiving a second secure transaction object key. The second secure transaction object key is used to identify the secure transaction object, which is temporarily stored in the secure transaction object record associated with the first secure transaction object. If the second secure transaction object key matches the first secure transaction object key, the secure transaction object generated during the operation 306 can be identified.

In an embodiment, the second secure transaction object key is received by a secure transaction server from a user device. In an example, the user device from which the second secure transaction object key is received is the same user device from which user information is received during the operation 302.

The operation 310 includes transmitting the secure transaction object. The secure transaction object that is transmitted is identified by matching the second secure transaction object key received during the operation 308 to the first secure transaction object key that is generated during the operation 304.

In an embodiment, the secure transaction object is transmitted from a secure transaction server to a user device. In an example, the secure transaction object is transmitted to the same user device from which the second secure transaction object key is received during the operation 308.

The operation 312 includes deleting the secure transaction object. By deleting the secure transaction object, the secure transaction object cannot be accessed by malicious actors trying to impersonate the user for which the secure transaction object was generated. In some embodiments, the user information that was received during the operation 302 is also deleted.

In an embodiment, the secure transaction object is deleted from a database on a secure transaction server. In some embodiments, user information is also deleted from the database on the secure transaction server.

In some particular embodiments, the secure transaction object key is retained after the secure transaction object is deleted. Because the secure transaction object may not be recoverable from the secure transaction object key, retention of the secure transaction object key at the secure transaction server 20 allows the secure transaction server 20 to retain a record of the particular user and identification document used to create a secure transaction object without retaining recoverable information of the secure transaction object itself. In some examples, other types of data (e.g., a different type of one-way hash of the secure transaction object or user information) may be stored and retained after a secure transaction object is transmitted to a user device. Such other data may be used to retain a record of the creation of the secure transaction object without retaining the secure transaction object itself.

In alternative embodiments, the method 300 may include additional or alternative operations. For example, in an alternative embodiment, the method 300 includes an operation that includes generating a digital travel credential. A virtual component of the digital travel credential may be used in the generation of the secure transaction object during the operation 306.

Additionally, in alternative embodiments, the operations 302, 304, 306, 308, 310, 312 may be performed in a different order than depicted in FIG. 3. For example, the secure transaction object may be generated before the first secure transaction object key is generated.

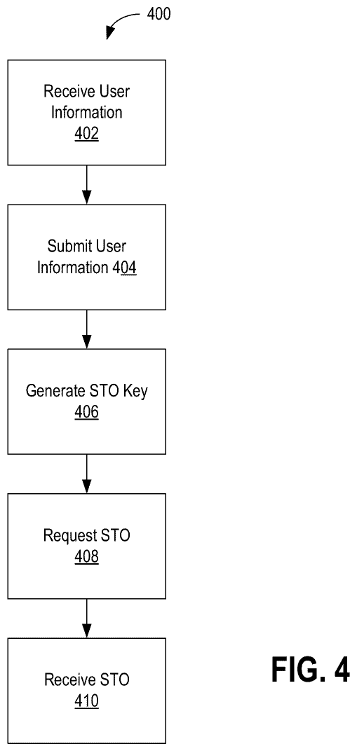

FIG. 4 illustrates a flowchart of an example method 400 of acquiring a secure transaction object. The method 400 includes operations 402, 404, 406, 408, 410. In an example, the method 400 may be performed by the system 100 described above in conjunction with FIG. 1 or the system 200 described above in conjunction with FIG. 2. For example, the method 400 may be performed by the user device 30 depicted in FIGS. 1 and 2.

The operation 402 includes receiving user information. As described above, in an embodiment, the user information includes biometric information or other identifying information of a user. In embodiments, the user information includes information associated with an identification document of the user (e.g., a passport), such as information stored in an integrated circuit embedded within the document.

In an embodiment, the user information is received by a user device. For example, the user information may be captured using an identity verification service library performing a data collection workflow.

The operation 404 includes submitting the user information. In an example, the user information is submitted to a server that uses the submitted user information to generate a secure transaction object key and a secure transaction object. In an embodiment, all of the user information captured during the operation 402 is submitted. In alternative embodiments, a subset of the information received during the operation 402 is submitted.

In an embodiment, a user device submits the user information to a secure transaction server. For example, the information may be submitted by an identity verification service library on the user device to an identity verification service application programming interface on the secure transaction server.

The operation 406 includes generating a secure transaction object key. In an embodiment, the secure transaction object key is generated using at least some of the user information received during the operation 402. For example, the secure transaction object key may be generated by creating a hash of the user information.

In an embodiment, the secure transaction object key is generated by a user device. For example, the secure transaction object key may be generated by an identity verification service library on the user device.

The operation 408 includes requesting a secure transaction object. In an embodiment, the secure transaction object is requested from a server using the secure transaction object key generated during the operation 406. For example, the secure transaction object key may be transmitted to the server, and if the server matches the secure transaction object key to a corresponding secure transaction object key, the server transmits back the secure transaction object associated with the secure transaction object key. The operation 410 includes receiving the secure transaction object. In an example, the secure transaction object may be used to authenticate the user in a future transaction. For example, as described further herein, the secure transaction object may include user biometric information or other identifying information that can be used to authenticate the user.

In an embodiment, a user device requests the secure transaction object from a server, and the user device receives the secure transaction object from the server. In an example, an identity verification service library on the user device requests and receives the secure transaction object from an identity verification service application programming interface. In embodiments, the secure transaction object is stored in a storage device of the user device after it is received.

In alternative embodiments, the method 400 includes additional or alternative operations. Additionally, in alternative embodiments, operations may be performed in a different order, or one or more operations may be performed simultaneously.

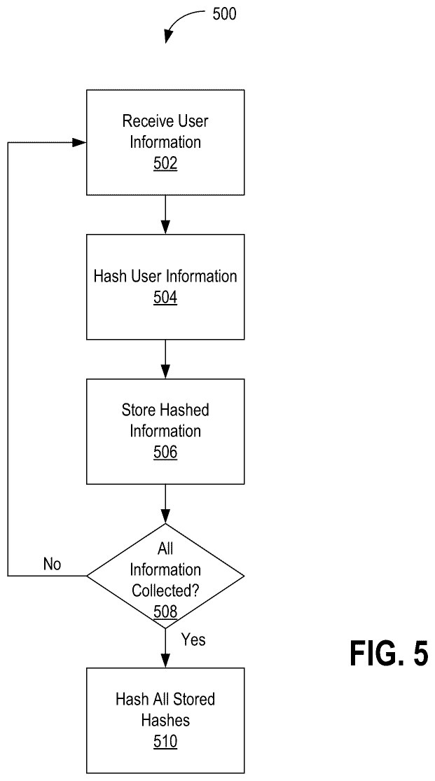

FIG. 5 illustrates a flowchart of an example method 500 of generating a secure transaction object key. The method 500 includes operations 502, 504, 506, 508, 510. In an example, the method 500 may be performed by the system 100 described above in conjunction with FIG. 1 or the system 200 described above in conjunction with FIG. 2. For example, the method 500 may be performed by the secure transaction server 20 or the user device 30 depicted in FIGS. 1 and 2.

The operation 502 includes receiving user information. The user information received during the operation 502 may be substantially similar to the user information described above with respect to the operation 302 of the method 300 depicted in FIG. 3 and the operation 402 of the method 400 depicted in FIG. 4. For example, the user information received during the operation 502 may include biometric information about a user and information about an identification document of the user.

In an embodiment, a secure transaction server may receive the user information from a user device. In an alternative embodiment, a user device may receive the user information from a user—for example, via user input or by capturing an image of the user or an identification document of the user. This this embodiment, the user device may capture user information during a data collection workflow.

The operation 504 includes generating a hash of the user information. In an example, a SHA-256 algorithm is used to hash the user information. In alternative embodiments, other hash functions may be used to generate a hash of the user information.

In an embodiment, the hash of the user information is generated by an identity verification service operating on a secure transaction server. In an alternative embodiment, the hash of the user information is generated on a user device using an identity verification service library.

The operation 506 includes storing the hash of the user information. In an example, a hash array is used to store hashes of user information. If the hash array is empty, the hash of the user information is stored in the first element of the hash array. If the hash array includes one or more elements, the hash of the user information is appended to the end of the hash array. In another example, a database stores records of hashes of user information.

In an embodiment, the hash of the user information is saved as a record in a database of a secure transaction server. In an alternative embodiment, the hash of the user information is added to a hash array in a storage of a user device. In an example, the hashes of the user information are stored in the following order: unique identifier for the data collection workflow, email and phone number, images or other information from an identity page and machine-readable zone of the user's passport, information from data group 2 of the user's passport, information for liveness checking (such as an image of the user), a self-portrait of the user, an image of the user's passport or other identification document, and an image of the user's fingerprint. In alternative embodiments, the user information may be stored in a different order or more user information may be included. Additionally, in some embodiments, one or more pieces of user information are not hashed. For example, the unique identifier for the data collection workflow may not be hashed.

The operation 508 includes determining if all user information has been collected. If more user information needs to be collected, the method 500 returns to the operation 502 where more user information is received. If all the user information has been collected, the method 500 proceeds to the operation 510.

In an embodiment, an identity verification service operating on a secure transaction server determines that all user information has been collected by receiving a message from a user device indicating that information capture is complete. In an alternative embodiment, an identity verification service library on a user device determines that all user information has been captured when a data collection workflow ends.

The operation 510 includes hashing all of the hashed user information that was previously stored. Like in the operation 504, a SHA-256 algorithm may be used to hash the hashed user information. In alternative embodiments, other hash functions may be used. In an example, the hashed user information is converted to a Base64 string before the final hash is generated. The final hash may be used as a secure transaction object key.

In an embodiment, an identity verification service operating on a secure transaction server hashes the stored hashes. In an alternative embodiment, an identity verification service library on a user device hashes the stored hashes.

As described above with respect to the operation 502, user information may be collected during a data collection workflow. Different embodiments of data collection workflows may collect different user data; for example, some data collection workflows may include liveness checking of a user, while others may not. In an embodiment, a secure transaction object key is generated based on the following information, which accounts for different data collection workflows including different steps: (1) IDVid (a unique identifier for the data collection workflow); (2) a hash of an email and a phone number if collected in an information step; (3) a hash of a Biopage or a machine-readable zone of a user's passport side image if the machine-readable zone of the user's passport is scanned; (4) a hash of data group 2 of the user's passport if data is collected from an embedded integrated circuit in the user's passport; (5) a hash of data group 2 of the user's passport if a virtual component of a digital travel credential of the user is loaded; (6) a hash of a liveness token that is used to start a liveness capture process if a liveness checking step is included; (7) a hash of a self-portrait of a user if it is captured; (8) a hash of an image of an identification document of the user if the identification document is imaged; (9) a hash of an image of the user's fingerprint if the user's fingerprint is imaged. A combined string is generated using this information and hashed to create the secure transaction object key. The following pseudocode provides an example of how the secure transaction object key is generated: hash (idvid+Base64 (hash1)+Base64 (hash2)+Base64 (hashN)). In an example, a SHA-256 algorithm is used to generate the hashes.

In alternative embodiments, the method 500 includes additional or alternative operations. Additionally, in alternative embodiments, operations may be performed in a different order, or one or more operations may be performed simultaneously.

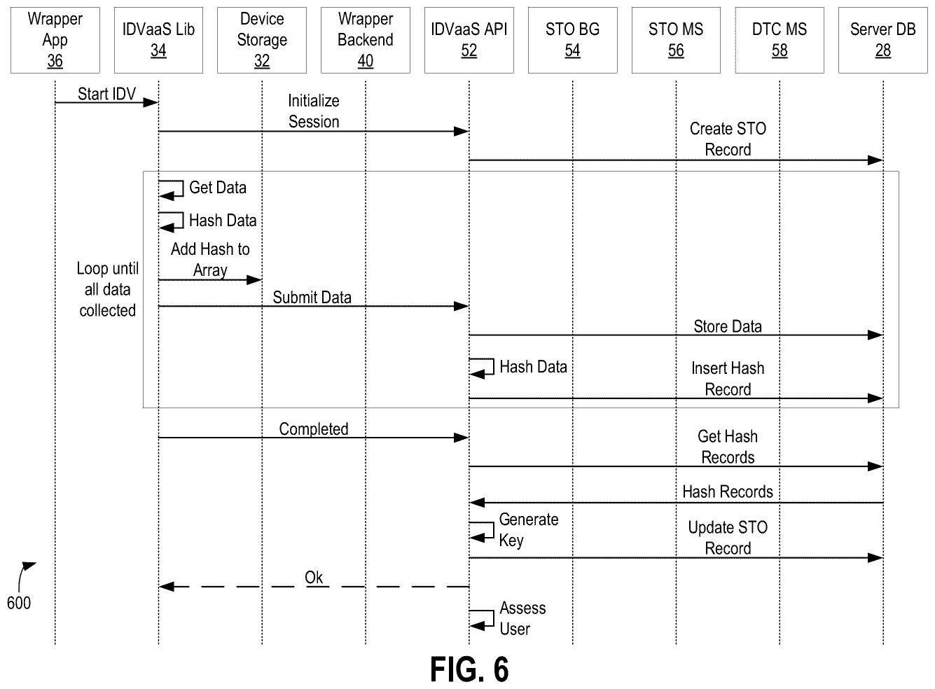

Turning to FIGS. 6-8, message flow diagrams 600, 700, 800 showing issuance of a secure transaction object are illustrated. The message flow diagrams 600, 700, 800 illustrate a secure transaction object issuance between a wrapper application 36, an identity verification service library 34, a device storage 32, a wrapper backend 40, an identity verification service application programming interface (API) 52, a secure transaction object background process 54, a secure transaction object microservice 56, a digital travel credential microservice 58, and a server database 28. In an embodiment, the wrapper application 36, the identity verification service library 34, and the device storage 32 are part of a user device, such as the user device 30 depicted in FIGS. 1 and 2. In an example, the wrapper application 36 is a third-party application. In this example, the wrapper backend 40 may be a third-party server. In an embodiment, the identity verification service API 52, the secure transaction object background process 54, the secure transaction object microservice 56, the digital travel credential microservice 58, and the server database 28 operate on a secure transaction server, such as the secure transaction server 20 depicted in FIGS. 1 and 2. In an example, the identity verification service API 52 is part of an identity verification service, the secure transaction object background process 54 and the secure transaction object microservice 56 are part of a secure transaction object management system, and the digital travel credential microservice 58 is part of a digital travel credential management system.

FIG. 6 illustrates the message flow diagram 600 showing generation of secure transaction object keys. Generation of the secure transaction object keys is initiated by the wrapper application 36 starting an identity verification process with the identity verification service library 34. In an example, the wrapper application 36 sends one or more identification numbers (IDs), such as a context ID and a correlation ID. In response to receiving the initialization message, the identity verification service library 34 initializes a session with the identity verification service API 52. In an example, the session initialization message includes the one or more IDs received from the wrapper application 36.

Upon receiving the session initialization message, the identity verification service API 52 creates a secure transaction object record in the server database 28. In an embodiment, the secure transaction object record includes a user ID and a status. In an example, when the secure transaction object record is initially created, the status is set as “new.”

After the session is initialized and the secure transaction object record is created, a user progresses through a data collection workflow. During the data collection workflow, data about the user is captured, such as biometric information or other identifying information. The data collection workflow includes steps that are looped until all necessary data is collected from the user. In embodiments, the collected data includes an identifier unique to the data collection workflow.

The identity verification service library 34 collects data, hashes the data, and adds the hashed data to an array in the device storage 32. The data is also sent from the identity verification service library 34 to the identity verification service API 52. The identity verification service API 52 stores the data in the server database 28, hashes the data, and stores the hashed data in the server database 28. In an example, the hashed data is stored in the server database 28 in a record along with the user ID and a name of the data. When all necessary data has been collected, the identity verification service library 34 sends a message to the identity verification service API 52 indicating that the data collection workflow is complete.

When the data collection workflow is completed, a first secure transaction object key is generated by the identity verification service API 52. The identity verification service API 52 sends a request for the hashed data to the server database 28, which responds with the hashed data. In an embodiment, the identity verification service API 52 sends the user ID with the request, and the server database 28 identifies hashed data associated with the user ID. In embodiments, the identity verification service API 52 generates the first secure transaction object key by hashing at least some of the hashed data.

After the first secure transaction object key is generated, it is stored in the server database 28. In an example, the first secure transaction object key is stored in the secure transaction object record in the server database 28. In this example, the first secure transaction object key is transmitted from the identity verification service API 52 to the server database 28 along with the user ID, and the server database 28 stores the first secure transaction object key in the secure transaction record associated with the user ID.

After the first secure transaction object key is generated, the identity verification service API 52 notifies the identity verification service library 34 that the first secure transaction object key is generated. The identity verification service API 52 also uses the user data collected during the data collection workflow to assess the user. In an example, the identity verification service API 52 determines whether the user is who he claims to be. For example, user biometric information is used to authenticate the user. In another example, the identity verification service API 52 may assess whether the user is a live person or a spoof (e.g., an image or other representation of the user). In another example, the identity verification service API 52 may determine whether an identification document from which data was collected belongs to the user. If the user passes the assessment, a secure transaction object is generated.

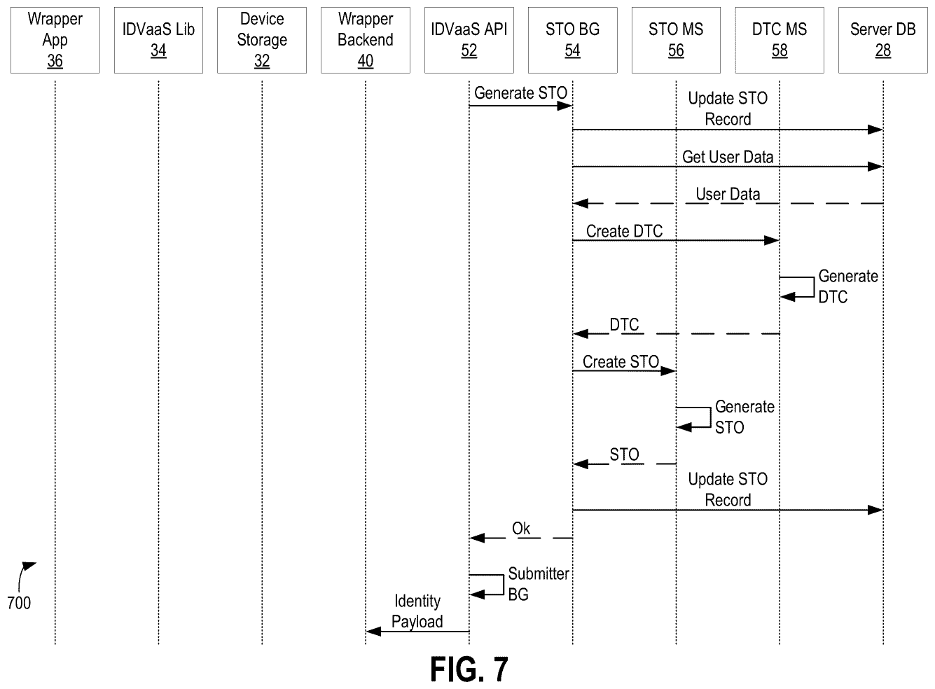

FIG. 7 illustrates the message flow diagram 700 showing generation of a secure transaction object. Generation of the secure transaction object is initiated by the identity verification service API 52 sending a message to the secure transaction object background process 54. The secure transaction object background process 54 updates the secure transaction object record in the server database 28. In an example, the secure transaction object background process 54 updates a status of the secure transaction object record to “in progress” to indicate that the secure transaction object is in the process of being generated. The secure transaction object background process 54 also requests user data from the server database 28. In an embodiment, the user data requested by the secure transaction object background process 54 is the user data previously collected during the data collection workflow. In an example, the data includes data from an identification document of the user. For example, the data may include a Document Security Object and data groups collected from an integrated circuit of the user's passport. In another example, the data includes biometric data of the user, such as a self portrait of the user. The server database 28 returns the requested data to the secure transaction object background process 54.

In some embodiments, the secure transaction object background process 54 uses at least some of the data to generate a digital travel credential. The secure transaction object background process 54 sends at least some of the data to the digital travel credential microservice 58. In an example, the data transmitted to the digital travel credential microservice 58 includes a Document Security Object and data groups collected from an integrated circuit of the user's passport. The digital travel credential microservice 58 generates the digital travel credential using the received data, and the digital travel credential is transmitted to the secure transaction object background process 54. In an embodiment, the digital travel credential microservice 58 generates the digital travel credential by encoding the received data in an ASNI format. In an example, the digital travel credential includes a list of data groups and the Document Security Object from the user's passport.

The secure transaction object is generated using at least some of the data. The secure transaction object background process 54 sends at least some of the data to the secure transaction object microservice 56, which generates the secure transaction object using the received data. In some embodiments, the secure transaction object microservice 56 may additionally or alternatively use the digital travel credential to generate the secure transaction object.

In an embodiment, the secure transaction object is generated as a plurality of attribute-value pairs, such as by using a JSON format. In an example, after generating the secure transaction object, the secure transaction object microservice 56 may sign the secure transaction object. In an embodiment, the secure transaction object microservice 56 may transmit the secure transaction object to an external key management system to sign the secure transaction object. In alternative embodiments, the secure transaction object microservice 56 may additionally or alternatively encrypt the secure transaction object. For example, the secure transaction object may be encrypted by the external key management system.

The secure transaction object microservice 56 transmits the secure transaction object to the secure transaction object background process 54. The secure transaction object background process 54 updates the secure transaction object record by sending the secure transaction object to the server database 28 and updating the status to “ready.” The secure transaction object background process 54 additionally sends a message to the identity verification service API 52 that the secure transaction object has been created. In some embodiments, the identity verification service API 52 performs a submitter background process and transmits an identity payload to the wrapper backend 40. In an example, the identity payload includes the user data collected during the data collection workflow.

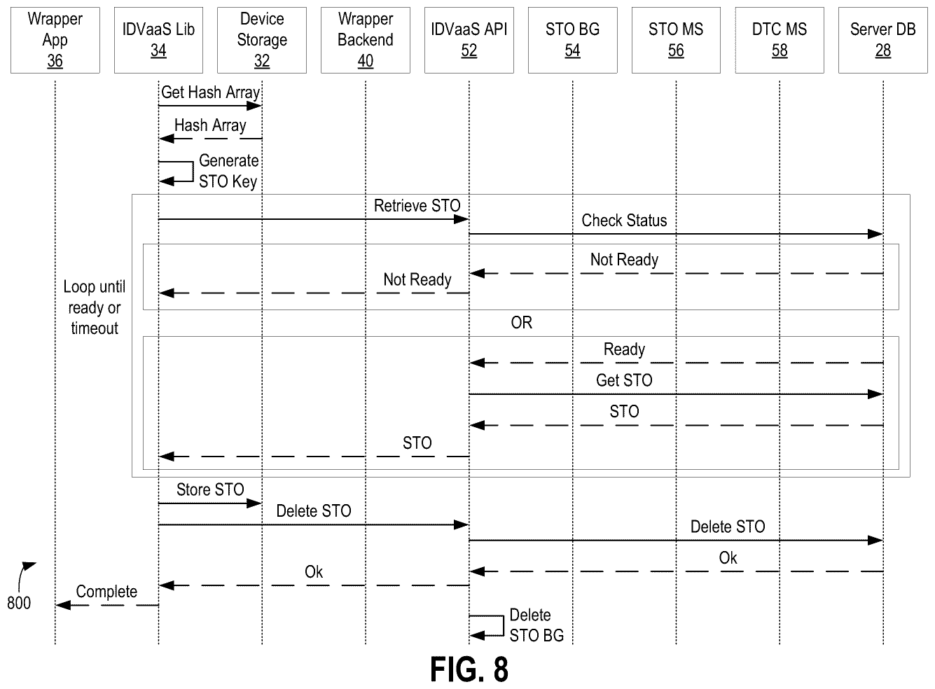

FIG. 8 illustrates the message flow diagram 800 for retrieving the secure transaction object at the user device. To retrieve the secure transaction object, the user device generates a second secure transaction object key and uses the key to retrieve the secure transaction object from the secure transaction server.

The identity verification service library 34 requests the hash array of hashed data from the device storage 32. The identity verification service library 34 uses a process substantially similar to the identity verification service API 52 to generate the second secure transaction object key using the hashed data—i.e., the second secure transaction object key is generated as a hash of the hashed data.

The identity verification service library 34 requests the secure transaction object from the identity verification service API 52 using the second secure transaction object key. The identity verification service API 52 checks the status of the secure transaction object in the server database 28 by finding the secure transaction object record with a key that matches the second secure transaction object key (i.e., the first secure transaction object key). If the secure transaction object is not ready, messages are transmitted from the server database 28 to the identity verification service API 52 and from the identity verification service API 52 to the identity verification service library 34 indicating that the secure transaction object is not ready. The identity verification service library 34 may then make another request for the secure transaction object from the identity verification service API 52. This process may loop until the secure transaction object is ready or until a timeout is reached.

If the secure transaction object is ready, the server database 28 informs the identity verification service API 52 that the secure transaction object is ready. The identity verification service API 52 requests the secure transaction object from the server database 28, and the secure transaction object is transmitted from the server database 28 to the identity verification service API 52 and from the identity verification service API 52 to the identity verification service library 34. As described above, the secure transaction object that is transmitted to the identity verification service library 34 may be signed. In embodiments, after the secure transaction object is retrieved from the server database 28, the status of the secure transaction object record is updated to “retrieved.” Additionally, in embodiments in which the secure transaction object is encrypted, the secure transaction object may be transmitted to the identity verification service library 34 in the encrypted state. In such embodiments, the secure transaction object can be transmitted back to the identity verification service API 52 to be decrypted. In an example, as described above, an external key management system may be used to decrypt the secure transaction object. Alternatively, the secure transaction object may be decrypted before being transmitted to the identity verification service library 34.

The identity verification service library 34 stores the secure transaction object in the device storage 32. In an embodiment, if the secure transaction object is not encrypted, the secure transaction object is encrypted before it is stored. The identity verification service library 34 requests that the identity verification service API 52 delete the secure transaction object from the server database 28. In some embodiments, the user data that was captured during the data collection workflow is also deleted. Like when retrieving the secure transaction object, the secure transaction object is identified to be deleted using the second secure transaction object key and matching the key with the first secure transaction object key. After the secure transaction object is deleted, confirmation messages are transmitted from the server database 28 to the identity verification service API 52 and from the identity verification service API 52 to the identity verification service library 34. The identity verification service library 34 informs the wrapper application 36 the secure transaction object has been issued.

In an embodiment, if the secure transaction object is stored in the server database 28 for longer than a threshold amount of time without being deleted, the identity verification service API 52 initiates a process to delete the secure transaction object, even if the secure transaction object has not yet been retrieved.

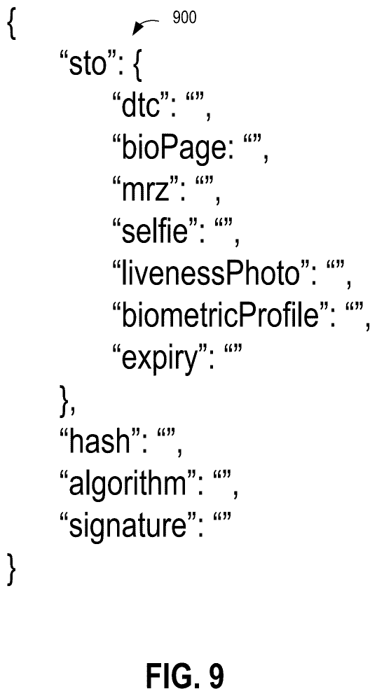

Turning to FIG. 9, an example embodiment of a secure transaction object 900 is shown. As described above, the secure transaction object 900 includes information about a user that can be used to authenticate the user in transaction, such as biometric information and information associated with an identification document of the user. In the example, the secure transaction object 900 includes a plurality of key-attribute pairs. In the illustrated embodiment, the secure transaction object 900 has a JSON format. In alternative embodiments, the secure transaction object 900 may have alternative formats.

In the illustrated embodiment, the secure transaction object includes information associated with a digital travel credential (“dtc”), an identity page of the user's passport (“bioPage”), a machine-readable zone of the user's passport (“mrz”), a self-portrait of the user (“selfie”), a photo of the user for liveness checking (“livenessPhoto”), a biometric template of the user (“biometricProfile”), and an expiration date of the secure transaction object (“expiry”). In some embodiments, some of the keys may not include associated attributes as the information to be stored as the attributes was not collected before generation of the secure transaction object 900.

In embodiments, information associated with the digital travel credential, the identity page of the user's passport, the self-portrait of the user, the photo of the user for liveness checking, and the biometric profile are stored in the secure transaction object 900 as a Base64 string. In embodiments, the information associated with the machine-readable zone of the user's passport is stored as plain text. In embodiments the expiration date of the secure transaction object 900 is stored as a string with a YYMMDD format.

In embodiments, the secure transaction object 900 is stored along with a hash of the secure transaction object 900 (“hash”), the algorithm used to hash the secure transaction object 900 (“algorithm”), and a public signature of the hash of the secure transaction object 900 (“signature”). In an embodiment, the hash of the secure transaction object 900 is stored as a Base64 string and the algorithm is stored as plain text.

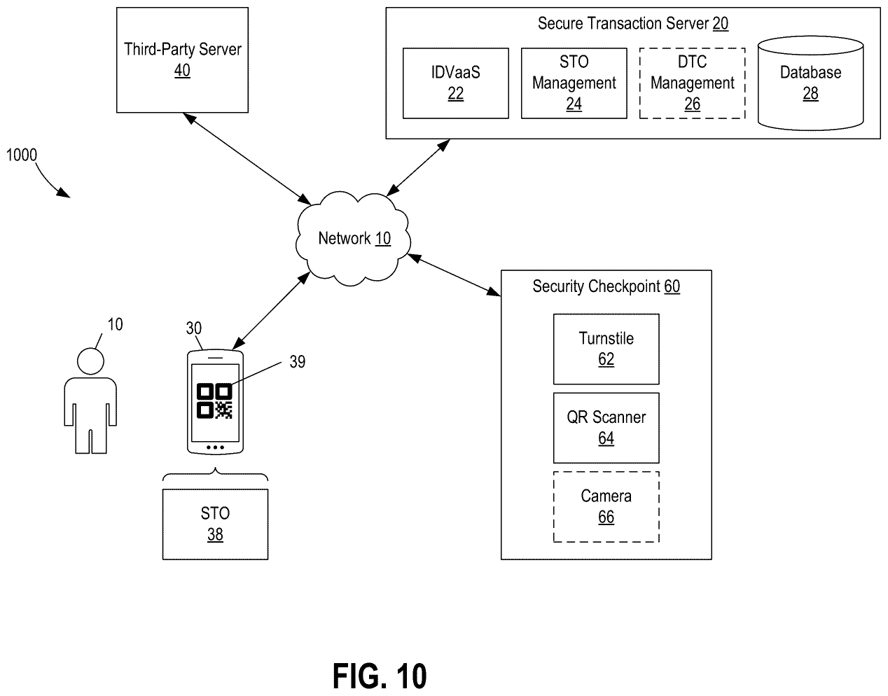

FIG. 10 illustrates an example system 1000 for use of a secure transaction object 38 in authenticating a user 10. The system 1000 is similar to the system 200 illustrated in FIG. 2 and further includes a security checkpoint 60. In the illustrated embodiment, the user 10 uses the secure transaction object 38 for authentication at the security checkpoint 60—for example, to board a flight or a train. In alternative embodiments, the user 10 may use the secure transaction object 38 for authentication for other transactions or interactions. In the illustrated embodiment, the security checkpoint 60 includes a turnstile 62 and a quick-response code (QR code) scanner 64. In some embodiments, the security checkpoint 60 may further include a camera 66 or other sensor for capturing biometric information or other identifying information about users.

In a first example, a user device 30 cooperates with a secure transaction server 20 to authenticate the user 10 with the secure transaction object 38. For example, the user 10 uses the user device 30 to capture a self-portrait of the user 10. The user device 30 transmits the captured self-portrait and the secure transaction object 38 to the secure transaction server 20. The secure transaction server 20 compares the captured self-portrait to a self-portrait of the user 10 stored in the secure transaction object 38 to authenticate the user 10; if the captured self-portrait meets a threshold similarity with the self-portrait stored in the secure transaction object 38, the secure transaction server 20 authenticates the user 10. In an embodiment, the secure transaction server 20 uses an identity verification system 22 to authenticate the user 10.

If the secure transaction server 20 authenticates the user 10, an approval response is transmitted from the secure transaction server 20 to the user device 30. In response to receiving the approval response, the user device 30 generates a QR code 39 including information indicating that the user 10 has been approved. The user 10 can then use the user device 30 to present the QR code 39 to the QR code scanner 64 of the security checkpoint 60. The security checkpoint 60 reads the QR code 39, determines that the user 10 is approved, and allows the user 10 to pass through the turnstile 62.

In a second example, the security checkpoint 60 additionally cooperates with the user device 30 and the secure transaction server 20 to authenticate the user 10 with the secure transaction object 38. Like with the previous example, an image of the user 10 is captured and compared against an image stored in the secure transaction object 38. However, in this example, the image of the user 10 is captured by the camera 66 of the security checkpoint 60.

The user device 30 displays a QR code 39 including information associated with a ticket of the user 10 (e.g., a train ticket), which is scanned by the QR scanner 64 of the security checkpoint 60. In response to scanning the QR code, the security checkpoint 60 activates the camera 66 to capture an image of the user 10. The image of the user 10 is transmitted to the secure transaction server 20 to use in authentication of the user 10.

The secure transaction server 20 also uses the secure transaction object 38 to authenticate the user 10. In an embodiment, the QR code 39 additionally includes information associated with the secure transaction object 38, allowing the security checkpoint 90 to receive the secure transaction object 38 when scanning the QR code 39. The security checkpoint 60 then transmits the secure transaction object 38 to the secure transaction server 20 along with the captured image. In an alternative embodiment, after the QR code 39 is scanned, the user device 30 transmits the secure transaction object 38 to the server.

As described above, the secure transaction server 20 compares the captured image to an image of the user 10 stored in the secure transaction object 38, such as by using the identity verification system 22. If the images sufficiently match, the user 10 is authenticated and an approval response is transmitted from the secure transaction server 20 to the security checkpoint 60. In response to receiving the approval response, the security checkpoint 60 allows the user 10 to pass through the turnstile 62.

In an embodiment, the security checkpoint 60 communicates directly with the secure transaction server 20. In an alternative embodiment, a third-party server 40 associated with the security checkpoint 60 acts as an intermediary between the security checkpoint 60 and the secure transaction server 20.

While these examples describe using an image captured of the user 10 and an image stored in the secure transaction object 38 to authenticate the user 10, in alternative examples, different biometric information or other identifying information may be used to authenticate the user 10.

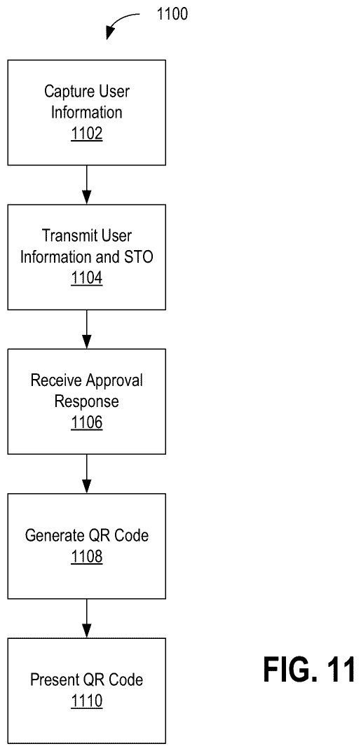

FIG. 11 illustrates a flowchart of an example method 1100 of authenticating a user using a secure transaction object. In the illustrated embodiment, the method 1100 includes operations 1102, 1104, 1106, 1108, 1110. In an example, the method 1100 is performed by the system 1000 described above in conjunction with FIG. 10. In an embodiment, the method 1100 is performed by the user device 30 depicted in FIG. 10.

The operation 1102 includes capturing user information. In an example, the captured user information includes a self-portrait of the user. In other examples, the user information may include other information about the user, such as biometric information or other identifying information. In embodiments, the types of user information captured during the operation 1102 matches at least one type of user information captured during creation of the secure transaction object and stored in the secure transaction object, as described above.

In an embodiment, the user information is captured by a user device of the user. For example, a camera of the user device may capture a self-portrait of the user.

The operation 1104 includes transmitting the captured user information as well as the secure transaction object to authenticate the user. In embodiments, the user information and secure transaction object are transmitted to a server at which the user is authenticated using the secure transaction object. In an example, the secure transaction object was previously generated using a process described above.

In an embodiment, the user information and the secure transaction object are transmitted from a user device to a secure transaction server. In examples, an identity verification service on the secure transaction server authenticates the user by comparing the user information to corresponding information stored in the secure transaction object.

The operation 1106 includes receiving an approval response. In examples, the approval response is received from the same system to which the user information and the secure transaction object were transmitted during the operation 1104. In embodiments, the approval response indicates that the user has been authenticated.

In an embodiment, a user device receives the approval response from a secure transaction server. In examples, the secure transaction server transmits the approval response in response to authenticating the user.

The operation 1108 includes generating a presentable object, such as a scannable graphical object. In some examples, the scannable graphical object may include a QR code or bar code. In such an example, the QR code includes encoded information indicating that the user has been approved. In alternative embodiments, other information may additionally or alternatively be included in the QR code or other scannable object. Additionally, in alternative embodiments, other types of visuals for storing information to be read by external devices may be generated, such as barcodes. The operation 1110 includes presenting the presentable object (e.g., QR code) generated during the operation 1108. In embodiments, the QR code is read by external devices to determine that the user has been authenticated.

In an embodiment, a user device generates and presents the QR code or other presentable object. In an example, the presentable object is read by a security checkpoint to determine that the user has been authenticated, and in response to determining that the user has been authenticated, the security checkpoint allows the user to pass through a turnstile.

In alternative embodiments, the method 1100 includes additional or alternative operations. Additionally, in alternative embodiments, operations may be performed in a different order, or one or more operations may be performed simultaneously.

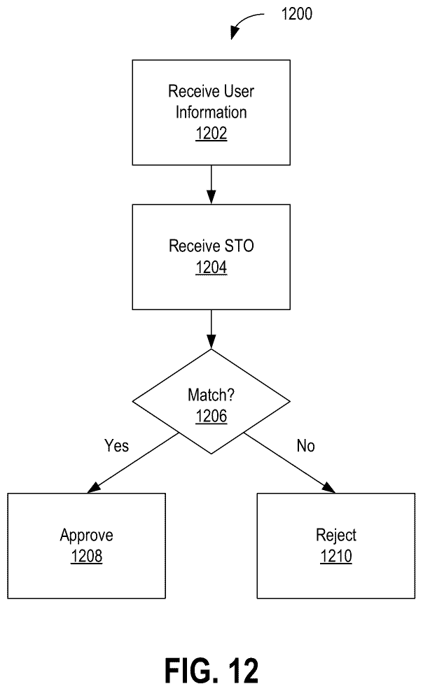

FIG. 12 illustrates a flowchart of an example method 1200 of authenticating a user using a secure transaction object. In the illustrated embodiment, the method 1200 includes operation 1202, 1204, 1206, 1208, 1210. In an embodiment, the method 1200 is performed the system 1000 described above in conjunction with FIG. 10. In an example, an identity verification service of a secure transaction server performs the method 1200.

The operation 1202 includes receiving user information. In an example, the user information includes a self-portrait of the user. In alternative examples, the user information includes additional or alternative user information, such as biometric information or other identifying information. In an embodiment, the type of user information received during the operation 1202 matches at least one type of user information stored in the secure transaction object. The operation 1204 includes receiving the secure transaction object.

In an embodiment, an identification verification service receives the user information and the secure transaction object from a user device.

The operation 1206 includes determining if the received user information matches user information stored in the secure transaction object. In an example, a self-portrait of the user in the received user information is compared against a self-portrait of the user stored in the secure transaction object. If the captured self-portrait meets a threshold similarity with the self-portrait stored in the secure transaction object, the user information is determined to match the information stored in the secure transaction object. In alternative embodiments additional or alternative user information is compared against additional or alternative information stored in the secure transaction object.

If the user information matches the information stored in the secure transaction object, the user is authenticated and the method 1200 proceeds to the operation 1208 where the user is approved. In an embodiment, the operation 1208 includes generating and transmitting an approval response. If the user information does not match the information stored in the secure transaction object, the user is not authenticated and the method 1200 proceeds to the operation 1210 where the user is rejected. In an embodiment, the operation 1210 includes generating and transmitting a rejection response.

In an embodiment, an identity verification service determines if the user information matches information stored in the secure transaction object, authenticates the user if the information matches, and sends an appropriate response. In an example, the response is transmitted from the identity verification service to a user device.

In an embodiment, the method 1200 includes additional or alternative operations. Additionally, in embodiments, the operations 1202, 1204, 1206, 1208, 1210 may be performed in a different order, or one or more operations may be performed simultaneously. For example, the user information and the secure transaction object may be received simultaneously.

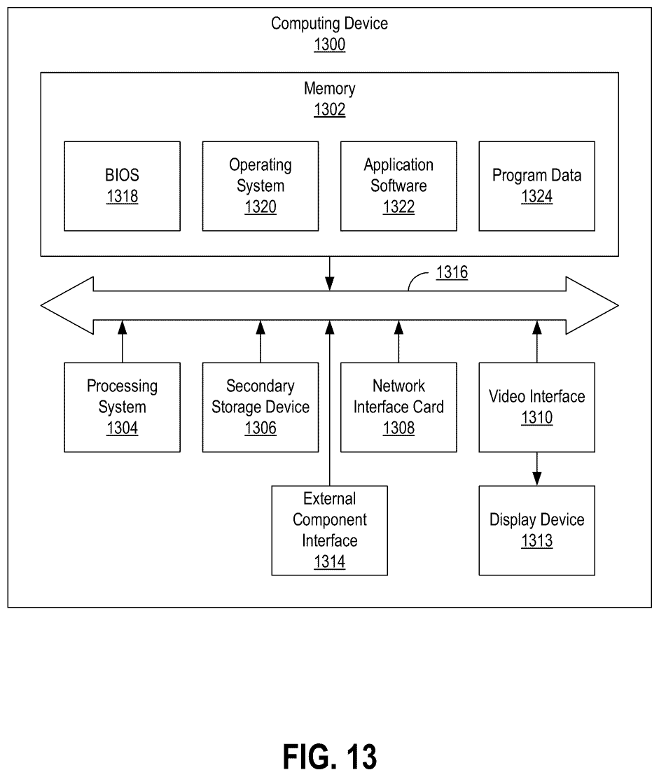

FIG. 13 illustrates an example computing device 1300 on which aspects of the present disclosure may be implemented. The computing device 1300 can be used, for example, to implement computing devices such as the user device 30, secure transaction server 20, or any other computing device useable as described above in connection with FIG. 1.

In the example of FIG. 13, the computing device 1300 includes a memory 1302, a processing system 1304, a secondary storage device 1306, a network interface card 1308, a video interface 1310, a display unit 1313, an external component interface 1314, and a communication medium 1316. The memory 1302 includes one or more computer storage media capable of storing data and/or instructions. In different embodiments, the memory 1302 is implemented in different ways. For example, the memory 1302 can be implemented using various types of computer storage media, and generally includes at least some tangible media. In some embodiments, the memory 1302 is implemented using entirely non-transitory media.

The processing system 1304 includes one or more processing units, or programmable circuits. A processing unit is a physical device or article of manufacture comprising one or more integrated circuits that selectively execute software instructions. In various embodiments, the processing system 1304 is implemented in various ways. For example, the processing system 1304 can be implemented as one or more physical or logical processing cores. In another example, the processing system 1304 can include one or more separate microprocessors. In yet another example embodiment, the processing system 1304 can include an application-specific integrated circuit (ASIC) that provides specific functionality. In yet another example, the processing system 1304 provides specific functionality by using an ASIC and by executing computer-executable instructions.

The secondary storage device 1306 includes one or more computer storage media. The secondary storage device 1306 stores data and software instructions not directly accessible by the processing system 1304. In other words, the processing system 1304 performs an I/O operation to retrieve data and/or software instructions from the secondary storage device 1306. In various embodiments, the secondary storage device 1306 includes various types of computer storage media. For example, the secondary storage device 1306 can include one or more magnetic disks, magnetic tape drives, optical discs, solid-state memory devices, and/or other types of tangible computer storage media.

The network interface card 1308 enables the computing device 1300 to send data to and receive data from a communication network. In different embodiments, the network interface card 1308 is implemented in different ways. For example, the network interface card 1308 can be implemented as an Ethernet interface, a fiber optic network interface, a wireless network interface (e.g., WiFi, WiMax, Bluetooth, etc.), or another type of network interface.

In optional embodiments where included in the computing device 1300, the video interface 1310 enables the computing device 1300 to output video information to the display unit 1313. The display unit 1313 can be various types of devices for displaying video information, such as an LCD display panel, a plasma screen display panel, a touch-sensitive display panel, an LED or OLED screen, a cathode-ray tube display, or a projector. The video interface 1310 can communicate with the display unit 1313 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 1314 enables the computing device 1300 to communicate with external devices. For example, the external component interface 1314 can be a USB interface and/or another type of interface that enables the computing device 1300 to communicate with external devices or peripheral devices integrated within the same housing (e.g., in the case of mobile devices). In various embodiments, the external component interface 1314 enables the computing device 1300 to communicate with various external components, such as external storage devices, input devices, speakers, modems, media player docks, other computing devices, scanners, digital cameras, and fingerprint readers.

The communication medium 1316 facilitates communication among the hardware components of the computing device 1300. The communication medium 1316 facilitates communication among the memory 1302, the processing system 1304, the secondary storage device 1306, the network interface card 1308, the video interface 1310, and the external component interface 1314. The communication medium 1316 can be implemented in various ways. For example, the communication medium 1316 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1302 stores various types of data and/or software instructions. The memory 1302 stores a Basic Input/Output System (BIOS) 1318 and an operating system 1320. The BIOS 1318 includes a set of computer-executable instructions that, when executed by the processing system 1304, cause the computing device 1300 to boot up. The operating system 1320 includes a set of computer-executable instructions that, when executed by the processing system 1304, cause the computing device 1300 to provide an operating system that coordinates the activities and sharing of resources of the computing device 1300. Furthermore, the memory 1302 stores application software 1322. The application software 1322 includes computer-executable instructions, that when executed by the processing system 1304, cause the computing device 1300 to provide one or more applications. In an example, the memory 1302 stores application software 1322 for a third-party application used in issuing secure transaction objects. The memory 1302 also stores program data 1324. The program data 1324 is data used by programs that execute on the computing device 1300.

Although particular features are discussed herein as included within an electronic computing device 1300, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include various types of dynamic random access memory (DRAM), solid state memory, read-only memory (ROM), electrically-erasable programmable ROM, magnetic disks (e.g., hard disks, floppy disks, etc.), and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is noted that, in some embodiments of the computing device 1300 of FIG. 13, the computer-readable instructions are stored on devices that include non-transitory media. In particular embodiments, the computer-readable instructions are stored on entirely non-transitory media.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. A method of generating secure transaction objects for authentication of users, the method comprising:
receiving user identifying information;
generating a first key based on at least some of the user identifying information;
generating a secure transaction object based on at least some of the user identifying information, wherein the secure transaction object is associated with the first key;
signing the secure transaction object;
receiving a second key;
in response to determining that the second key matches the first key, transmitting the secure transaction object; and
deleting the secure transaction object after transmission.

2. The method of claim 1, wherein generating the first key on at least some of the user identifying information includes:
generating a hash of a first piece of information in the user identifying information;
generating a hash of a second piece of information in the user identifying information;
combining the hash of the first piece of information and the hash of the second piece of information to form a combination; and
hashing the combination.

3. The method of claim 1, wherein the first key and the secure transaction object are generated based on the same user identifying information.

4. The method of claim 1, wherein the user identifying information includes at least one of a self-portrait of a user, contact information of the user, an image of an identification document of the user, data embedded on an integrated circuit in the identification document, and an image of a fingerprint of the user.

5. The method of claim 1, further comprising:
generating a digital travel credential,
wherein generating the secure transaction object is further based on the digital travel credential.

6. The method of claim 5, wherein the digital travel credential is generated based on data embedded on an integrated circuit in an identification document of the user.

7. The method of claim 1, further comprising:
verifying, using the signature, that the secure transaction object has not been altered.

8. The method of claim 1, further comprising:
encrypting the secure transaction object.

9. The method of claim 1, wherein the secure transaction object comprises one or more attribute-value pairs.

10. The method of claim 9, wherein the secure transaction object has a JSON format.

11. A method of generating secure transaction objects for authentication of users, the method comprising:
receiving user identifying information;
submitting the user identifying information to a server;
generating a key based on at least some of the user identifying information;
requesting, from the server, a secure transaction object, wherein the request includes the key; and
receiving, from the server, the secure transaction object if the key matches a corresponding key generated by the server.

12. The method of claim 11, wherein generating the key on at least some of the user identifying information includes:
generating hash of a first piece of information in the user identifying information;
generating a hash of a second piece of information in the user identifying information;
combining the hash of the first piece of information and the hash of the second piece of information; and
hashing the combination.

13. The method of claim 12, wherein a SHA-256 algorithm is used to hash the first piece of information.

14. The method of claim 11, wherein the user identifying information includes at least one of a unique data collection workflow identifier, biometric information of a user, an image of the user, and data embedded on an integrated circuit in an identification document of the user.

15. The method of claim 11, wherein the secure transaction object includes information associated with at least one of a digital travel credential, an identity page of a passport of a user, a machine-readable zone of the passport of the user, a self-portrait of the user, a photo of the user for liveness checking, a biometric template of the user, and an expiration date of the secure transaction object.

16. A system for generating secure transaction objects for authentication of users, the system comprising:
one or more processors; and
one or more computer-readable storage devices storing data instructions that, when executed by the one or more processors, cause the system to:
receive user identifying information;
generate a first key based on at least some of the user identifying information;
generate a secure transaction object based on at least some of the user identifying information, wherein the secure transaction object is associated with the first key;
receive a second key;
in response to determining that the second key matches the first key, transmit the secure transaction object; and
delete the secure transaction object after transmission.

17. The system of claim 16, wherein first key and the secure transaction object are generated based on different user identifying information.

18. The system of claim 16, wherein the first key is generated based on all of the user identifying information.

19. The system of claim 16, further storing instructions that, when executed by the one or more processors, cause the system to:
generate a digital travel credential,
wherein generation of the secure transaction object is further based on the digital travel credential.

20. The system of claim 19, wherein the digital travel credential is generated based on at least some of the user identifying information.
